(19) United States
(12) Patent Application Publication
(10) Pub. No.: US 2004/0161220 A1
(43) Pub. Date: Aug. 19, 2004

(54) Method for face-mounting optical components and devices using same

(75) Inventors: Jeffrey P. Treptau, Lakeville, MN (US); Thomas J. Schmitt, Apple Valley, MN (US); John Holman, Coon Rapids, MN (US)

Correspondence Address: CARLSON, CASPERS, VANDENBURGH & LINDQUIST, 225 SO. 6TH STREET, SUITE 3200, MPIS, MN, 55402, US

(73) Assignee: ADC Telecommunications, Inc., Eden Prairie, MN

(21) Appl. No.: 10/655,735

(22) Filed: Sep. 5, 2003

Related U.S. Application Data
(60) Provisional application No. 60/409,378, filed on Sep. 9, 2002.

(51) Int. Cl. G02B 6/00; G02B 6/36

(52) U.S. Cl. 385/137; 385/78

(57) ABSTRACT

In an improved approach to mounting optical elements in a fiber optic device, the positioning and orientation of the element are more accurate and the temperature dependent variations of the position and orientation are reduced. The mount has a protruding tip contact region on a mounting surface. Adhesive is supplied between the optical element and the mounting surface, and the optical element is pressed into contact with the protruding contact tip region, substantially expelling the adhesive from between the optical element and the protruding contact tip region. The adhesive is cured at a temperature exceeding the predetermined temperature range. This permits the adhesive to pull the element on to the contact tip region throughout the operating temperature range. This also permits the optical element to contact the mounting surface so that the optical element's surface is oriented parallel to the mounting plane.

### FIELD OF THE INVENTION

The present invention is directed generally to fiber optical devices, and more particularly to an approach for mounting optical elements used in the fiber optical devices.

### BACKGROUND

Optical fibers find many uses for directing beams of light between two points. Optical fibers have been developed to have low loss, low dispersion, polarization maintaining properties and can be incorporated into several different types of devices, such as amplifiers, filters, lasers and interferometers. As a result, optical fiber systems find widespread use, for example in optical communications.

However, one of the important advantages of fiber optic beam transport, that of enclosing the optical beam to guide it between terminal points, is also a limitation. There are several optical components, important for use in fiber systems or in fiber system development, that are not implemented in a fiber-based form where the optical beam is guided in a waveguide. Instead, these optical components are implemented in a bulk form, and through which the light propagates freely. Examples of such components include, but are not limited to, filters, isolators, circulators, polarizers, switches and shutters. Consequently, the inclusion of a bulk component in an optical fiber system necessitates that the optical fiber system have a section where the beam path propagates freely in space, rather than being guided within a fiber.

Free space propagation typically requires use of collimation units at the ends of the fibers to produce and receive collimated beams. In some units, the same focusing element is used to collimate the beams from two different fibers placed at different positions relative to the axis of the focusing optic. This produces collimated beams that propagate in non-parallel directions. The nonparallel propagation of the collimated beams introduces extra issues for aligning the components of the device, and may place some limits on making the device smaller in size.

A fiber optical device typically includes a collimation unit at each end, to produce a collimated light beam in the region of free-space propagation. The collimation unit typically includes one or more lenses to collimate the light passing to or from a fiber. Bulk optical elements, such as filters, polarizers, and isolator units having birefringent elements and non-reciprocating elements, are disposed in the collimated light beam, or light beams to perform the desired function. The placement of these elements in the collimated light beams is important, since the position along the beam or angle relative to the beam may affect the operation of the device. There is a need, therefore, to ensure that the elements are mounted at the desired position and orientation, and that the desired position and orientation are maintained over a range of possible operating temperatures.

### SUMMARY OF THE INVENTION

Accordingly, there is a need for an improved approach to mounting optical elements in a fiber optic device that improves the positioning and orientation of the element and that reduces the temperature dependent variation of the position and orientation.

One embodiment of the invention is directed to a method of mounting an optical element to a mount for use in a predetermined temperature range, where the mount has a protruding tip contact region on a mounting surface. The method includes providing adhesive between the optical element and the mounting surface, and pressing the optical element into contact with the protruding contact tip region thereby substantially expelling the adhesive from between the optical element and the protruding contact tip region. The adhesive is cured at a temperature exceeding the predetermined temperature range.

Another embodiment of the invention is directed to an optical device for use in a predetermined temperature range. The device includes a mount having a first mounting surface provided with a protruding tip contact region, where the protruding tip contact region defines a mounting plane. An element to be mounted has a second mounting surface contacting the protruding tip contact region. Adhesive is attachingly disposed between portions of the first and second mounting surfaces not in mutual contact.

Another embodiment of the invention is directed to a fiber optic device that includes a mount having a first mounting surface defining a first mounting plane. An optical element is adhesively surface mounted to the first mounting surface of the mount, a second mounting surface of the optical element contacts the first mounting surface of the mount so that the second mounting surface is parallel to the first mounting plane.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a fiber optic communications system in which a tap is used to split off light for monitoring the optical signal on an optical fiber, according to an embodiment of the present invention;

FIG. 2 schematically illustrates an embodiment of a fiber optic tap monitor according to the present invention;

FIG. 3 schematically illustrates an embodiment of a WDM device according to the present invention;

FIG. 4 schematically illustrates a partial cross-section of a conventional fiber optic device;

FIG. 5A schematically illustrates an exploded view of a dual fiber collimator according to an embodiment of the present invention;

FIG. 5B presents a cross-sectional view of the lens/filter mount illustrated in FIG. 5A;

FIGS. 6A and 6B schematically illustrate a partial cross-section of a lens/filter mount, before and after mounting an optical element respectively, according to an embodiment of the present invention;

FIG. 7A schematically illustrates a conventional mount showing problems arising from a varying thickness in an adhesive layer;

FIG. 7B schematically illustrates an embodiment of the present invention showing that the optical element lies in the mounting plane; and

FIG. 8 schematically illustrates another embodiment of a mount for mounting an optical element according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to fiber optic devices, and is believed to be particularly useful with fiber optic devices that include optical elements that are face-mounted within the device. Face-mounted elements include, for example, filters such as may be used in wavelength division multiplexed (WDM) devices or tap monitors, polarizers, birefringent plates, polarization rotators and the like.

A WDM device is used to combine light at different wavelengths into a single optical signal or, in reverse, to separate different wavelength components of an optical signal. A fiber optic tap is important for extracting a fraction of the light propagating along a fiber so as to permit the optical signal to be monitored. Different types of monitors may be used, including a tap monitor and a channel monitor. In the tap monitor, the tapped fraction of the light is directed to a photodetector to measure the total power in the optical signal. A channel monitor is typically used in multiple channel communications systems, for example, dense wavelength division multiplexed (DWDM) systems. The channel monitor splits the tapped fraction of light into its separate channels and measures the amount of light in each channel individually. This permits the operator to determine whether the power in the multiple channel optical signal is evenly distributed among all optical channels.

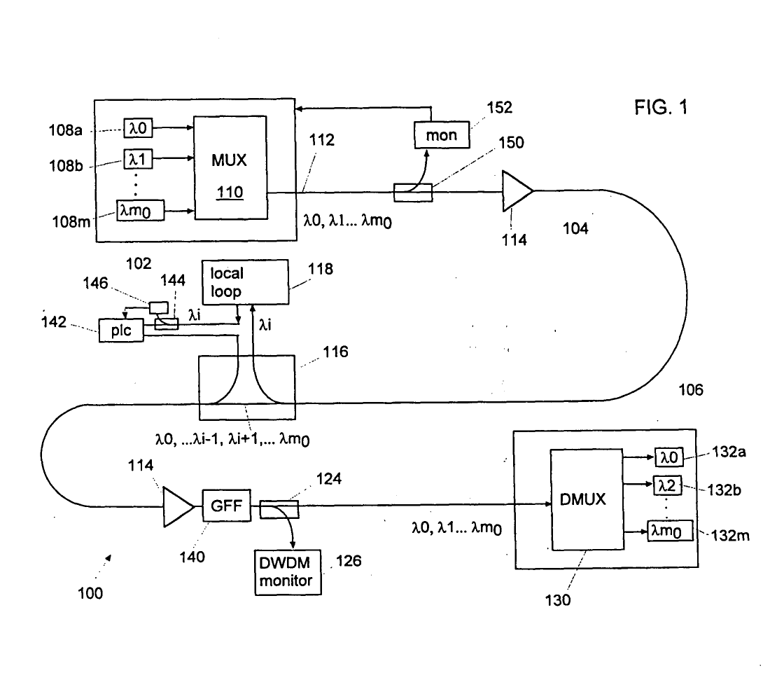

A schematic of an embodiment of an optical communications system 100 is presented in FIG. 1, showing how taps are employed to produce monitor signals. A DWDM transmitter 102 directs a DWDM signal having m₀ channels through a fiber communications link 104 to a DWDM receiver 106.

In this particular embodiment of DWDM transmitter 102, a number of light sources 108a-108m generate light at different wavelengths, λ0, λ1 . . . λm₀, corresponding to the different optical channels. The light output from the light sources 108a-108m is combined in a DWDM combiner unit 110, or multiplexer (MUX) unit to produce a DWDM output 112 propagating along the fiber link 104.

Light sources 108a-108m may be modulated laser sources, or laser sources whose output is externally modulated, or the like. It will be appreciated that the DWDM transmitter 102 may be configured in many different ways to produce the DWDM output 112. For example, the MUX unit 110 may include filter multiplexers and/or an interleaver to interleave the outputs from different multiplexers. Furthermore, the DWDM transmitter 102 may be equipped with any suitable number of light sources for generating the required number of optical channels. For example, there may be twenty, forty or eighty optical channels, or more. The DWDM transmitter 102 may also be redundantly equipped with additional light sources to replace failed light sources.

Upon reaching the DWDM receiver 106, the DWDM signal is passed through a demultiplexer unit (DMUX) 130, which separates the multiplexed signal into individual channels that are directed to respective detectors 132a-132m.

The fiber link 104 may include one or more fiber amplifier units 114, for example rare earth-doped fiber amplifiers, Raman fiber amplifiers or a combination of rare earth-doped and Raman fiber amplifiers. The fiber link 104 may include one or more DWDM channel monitors 126 for monitoring the power in each of the channels propagating along the link 104. Typically, a fraction of the light propagating along the fiber link 104 is coupled out by a tap coupler 124 and directed to the DWDM channel monitor 126. The fiber link 104 may also include one or more gain flattening filters 140, typically positioned after an amplifier unit 114, to make the power spectrum of different channels flat. The channel monitor 126 may optionally direct channel power profile information to the gain flattening filter 140. The gain flattening filter 140 may, in response to the information received from the channel monitor 126, alter the amount of attenuation of different channels in order to maintain a flat channel power profile, or a channel power profile having a desired profile.

The fiber link 104 may include one or more optical add/drop multiplexers (OADM) 116 for, for example, directing one or more channels to a local loop. In the particular embodiment illustrated, the OADM 116 drops the ith channel, operating at wavelength λi, and directs it to the local loop 118. The local loop 118 also directs information back to the OADM 116 for propagating along the fiber link 104 to the DWDM receiver 106. In the illustrated embodiment, the information added at the OADM 116 from the local loop 118 is contained in the ith channel at λi. It will be appreciated that the information directed from the local loop 118 to the OADM 116 need not be at the same wavelength as the information directed to the local loop 118 from the OADM 116. Furthermore, it will be appreciated that the OADM 116 may direct more than one channel to, and may receive more than one channel from, the local loop 118.

The amount of light being added to the fiber link 104 from the local loop 118 may be monitored and controlled so that the optical power added in the channel at λi is at approximately the same level as the power in the other channels λ0 to λi-1, and λi+1 to λm₀. The light from the local loop 118 may be passed through a power level controller 142 (plc) that controls the level of power in the channels being added in the OADM 116. The power level controller 142 may include a variable attenuator to reduce power and/or an amplifier to increase power. A tap 144 extracts a fraction of the light and passes the extracted light to the monitor 146 that detects the power of the light being added in the OADM 116. The monitor 146 directs a signal to the power level controller 142 which adjusts the power of the light upwards or downwards, depending on the signal received from the monitor 146, so as to set the power of the light being added at the OADM 116 to be approximately the same as that of the other channels.

A tap 150 and monitor 152 may also be positioned to monitor the DWDM signal 112 emitted by the transmitter 102. The monitor 152 may feed back a control signal to the transmitter 102 to control the level of the DWDM signal 112, based upon the power level detected by the monitor 152.

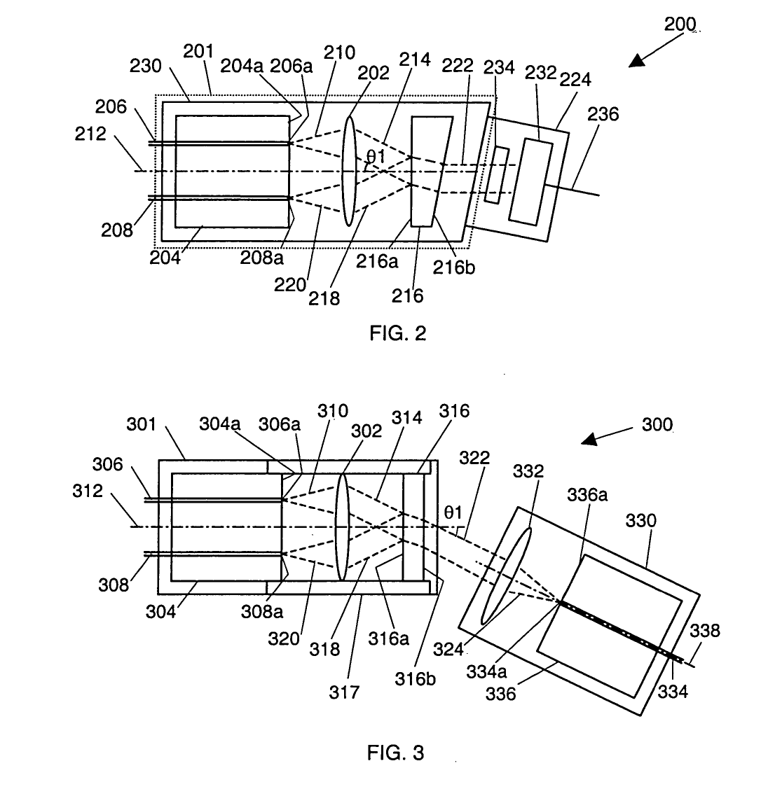

One type of tap monitor 200 is schematically illustrated in FIG. 2, and is described in greater detail in U.S. Pat. No. 09/999,533. The tap monitor 200 includes a dual fiber collimator 201 having a first lens 202 and dual-fiber ferrule 204. Two fibers 206 and 208 are held in the ferrule 204, with their ends 206a and 208a positioned at a distance from the lens 202 equal to about the focal length of the lens 202. The ferrule end 204a, and the fiber ends 206a and 208a may be polished at a small angle, approximately 1°-8° or so, to prevent reflections feeding to other elements.

The lens 202 may be a GRIN lens or may be a lens having a curved refracting surface. For example, the lens 202 may be an aspheric lens. The lens 202 may be formed from glass, an optically transmitting polymer, or other suitable transmitting material. The focal length of the lens 202 is typically in the range 1 mm-5 mm, although it may lie outside this range.

In the illustrated embodiment, a first light beam 210, from the first fiber 206, passes through the lens 202 and is collimated. However, since the beam 210 is not positioned on the lens axis 212, the collimated beam 214 propagates at an angle, θ1, to the axis 212. The value of θ1 is typically in the range 1.5°-2.5°, although it is not restricted to this range. The collimated beam 214 is incident on the filter 216, which has a reflective coating on its front surface 216a. The reflectivity of the reflective coating is typically high, and may be in the range 90%-99.9%, so that only a small fraction (0.1%-10%) of the power in the beam 214 is transmitted through the filter 216. The light 218 reflected by the filter 216 is directed to the first lens 202 which focuses the beam 220 to the second fiber 208. The filter 216 may also transmit a portion of a particular wavelength band or an individual optical channel, to permit monitoring of that wavelength band or individual channel.

The light 222 transmitted through the filter 216 passes to a photodetector unit 224, which detects the power of the transmitted beam 222. The photodetector unit 224 may be a photodiode, or other type of light detecting device. Where the photodetector unit 224 is based on a semiconductor material, the band gap of the semiconductor is advantageously arranged to be less than the energy of the photons being detected. For example, the light entering the tap monitor 200 may be an optical communications signal having a wavelength in the range 1300-1650 nm. Accordingly, the photodetector unit 224 may be based on a semiconducting material that absorbs light in this wavelength range, for example indium gallium arsenide and the like.

In this particular embodiment, the filter 216 is wedged at an angle, for example around 5°, so that refraction of the transmitted beam 222 by the filter 216 directs the beam 222 along a direction parallel to the optical axis 212 of the first lens 202, towards the photodetector 224. The DFC 201 is aligned within a housing 230, with its axis 212 substantially parallel to the axis of the housing 230. Therefore, the transmitted beam 222 propagates largely parallel to the housing 230. The use of a wedged element to produce a light beam propagating parallel to the axis from a dual fiber collimator is discussed further in U.S. patent application Ser. No. 09/999,891, entitled “DUAL FIBER COLLIMATOR ASSEMBLY POINTING CONTROL”, filed on Oct. 31, 2001 and incorporated herein by reference. Typically, the first surface 216a of the filter has the reflective coating while the second surface 216b has an antireflection coating.

In an example of a device as illustrated in FIG. 2, the fibers 206 and 208 have a diameter of around 125 μm and are set in the dual-fiber ferrule 204 at a center-to-center spacing of 125 μm. The lens 202 is aspherical, having a focal length in the range 1.5-2.5 mm, and so θ1 has a value of approximately 1.5°-2.5°. The filter 216 may be based on a substrate formed of glass, such as BK7 or B270 glass, and have a wedge angle of around 4.8°. It is to be understood that the values for the various components provided in this paragraph are provided for illustrative purposes only, and are not intended to limit the invention in any way. For example, the wedge angle of the filter 216 depends on the angle of incidence on the filter face 316a and the refractive index of the filter glass substrate, and may range from 2°-5° or more. Although the illustrated embodiment includes a wedged filter, the invention is not restricted to the use of wedged filters that parallelize the transmitted light with the lens axis. The light passed through the filter may propagate in a direction non-parallel to the axis 212.

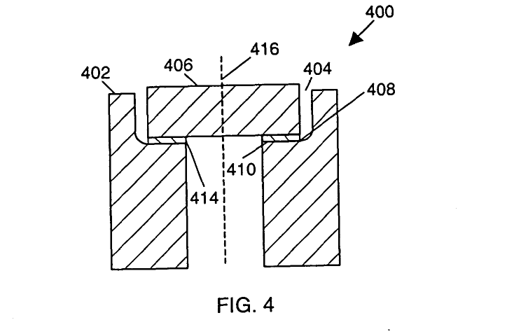

Another type of filter-based device, a WDM 300, is schematically illustrated in FIG. 3. A dual-fiber collimator 301 includes a first lens 302 and a dual-fiber ferrule 304. The first lens 302 is mounted on a lens/filter mount 317. Two fibers 306 and 308 are held in the ferrule 304, with their ends 306a and 308a positioned at a distance from the lens 302 equal to about the focal length of the lens 302. The ferrule end 304a, and the fiber ends 306a and 308a may be polished at a small angle to prevent reflections feeding to other elements.

A first light beam 310, from the first fiber 306, passes through the lens 302 and is collimated. However, since the beam 310 is not positioned on the lens axis 312, the collimated beam 314 propagates at an angle, θ1, to the axis 312. For typical systems, the value of θ1 may be around 2°, depending on such factors as the focal length of the lens 302 and the separation between the two fibers 306 and 308.

The collimated beam 314 is incident on the filter 316, which is mounted on the lens/filter mount 317. The filter 316 reflects a portion of the beam 314 as a reflected beam 318, and transmits the remainder of the beam 314 as a transmitted beam 322. The reflected beam 318 is reflected to the first lens 302 which focuses the beam 320 to the second fiber 308.

The transmitted beam 322 passes through the filter 316 to a single fiber collimator unit (SFC) 330. The SFC 330 includes a lens 332 and a fiber 334 that is held in the single fiber ferrule 336. When used in conjunction with the DFC 301 and the filter 316, the transmitted beam 322 is focused by the lens 332 into the third fiber 334 as beam 324. In this embodiment, the third fiber 334 is disposed on the axis 338 of the lens 332, and the SFC 330 is oriented so that the beam 322 from the DFC 301 is parallel to the axis 338. The ferrule end 336a and the fiber end 334a may be polished at a small angle to prevent reflections feeding back to other elements.

The filter 316 may have a multilayer dielectric filter coating, typically on the first surface 316a, with the second surface 316b having an anti-reflection coating. The filter 316 may transmit a fraction of the light incident from the first fiber 306 to the third fiber 334. For example, where the light 310 contains light in multiple optical channels at different channel wavelengths, the filter 316 may transmit light in only one or a small number of optical channels, reflecting the remaining light to the second fiber 308. The filter 316 may also be wedged so that the light 322 that is passed through the filter from the first fiber 302 propagates in a direction parallel to the lens axis 312.

A filter-based WDM device 300 may be useful for adding or dropping channels in a multi-channel optical communications system. The device may also be used for combining light at light at different wavelengths into a single output, or for separating light at different wavelengths into different outputs.

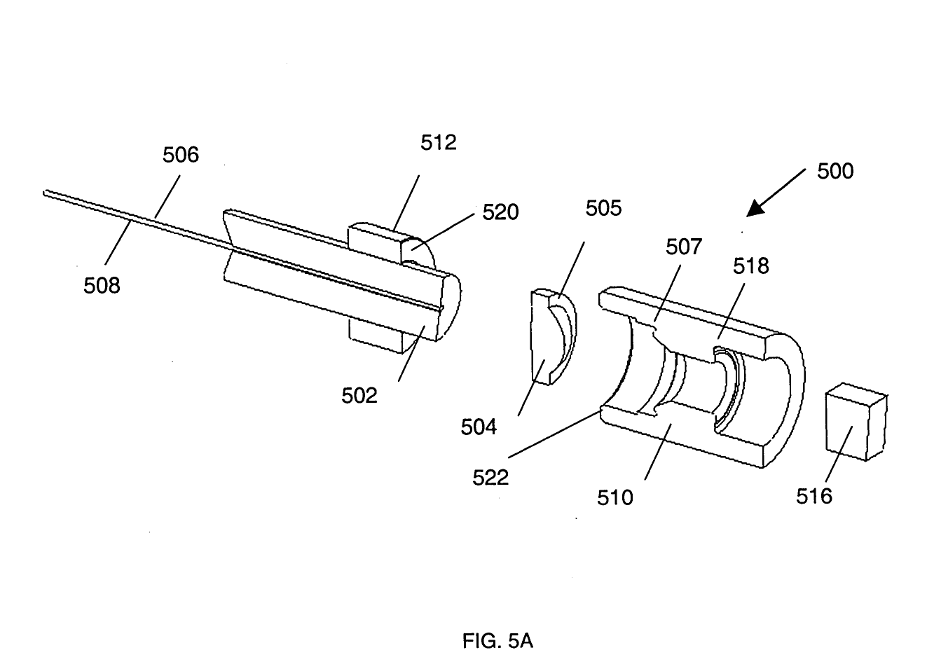

In many situations, it is important for fiber optic devices, including taps and WDMs, that various characteristics such as insertion loss, return loss, etc. be as independent of temperature as possible. In many conventional fiber optic devices, the filter is glued to a holder that positions the filter relative to the collimating lenses. A cross-section of part of a conventional fiber device 400 is illustrated in FIG. 4, which shows a mount 402 having a recess 404 for mounting an optical element, such as a filter, lens, polarizer, birefringent plate, or any other type of bulk optical element that may be used in a fiber optic device.

A lip 408 in the recess provides a flat surface 410 against which the element 406 may be glued. However, a layer of glue 414, generally of indeterminate thickness, remains between the flat surface 410 and the element 406 due to capillary action, even after the element 406 has been pressed against the flat surface 410. The absolute thickness of the layer of glue 414 is typically not well controlled and may vary from assembly to assembly. Furthermore, the thickness of the glue layer 414 may vary around the element 406 so that the orientation of the element relative to the axis 416 is not well controlled. Consequently, even if the mount 402 is fabricated with extremely small tolerances on its mounting faces, the uncertainty in the thickness of the glue layer 414 results in an uncertainty in the orientation of the element 406, and so the orientation of the mount 402 may have to be adjusted when inserting it into a collimator unit.

Various factors may affect the thermal stability of the device 400. For example, where the layer of glue 414 is thicker on one side of the mount 402 than the other, any thermal expansion or contraction may result in a tilting of the element 406. Also, if the glue 414 is not extremely homogeneous, for example, due to incomplete mixing of the different glue components, different regions of the glue layer 414 may manifest different temperature-dependent thicknesses, which also leads to tilting of the element 406. Several characteristics of the device 400, such as return loss and insertion loss, may be critically dependent on the tilt of the element, for example where the element 406 is a filter, and, consequently, may change with temperature. For example, a tilt of one side of a filter through 0.01° may lead to a change in the insertion loss of as much as 0.01 dB.

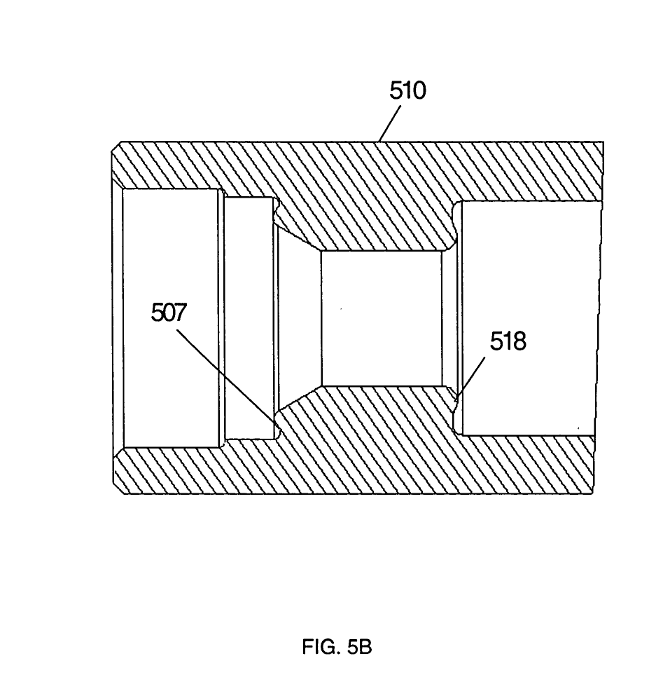

It is often advantageous to reduce the temperature dependence of the device characteristics. It is also often advantageous to ensure that the element 406 is mounted with an orientation relative to the mount 402 that is as precise as possible. An exploded view of an embodiment of a DFC 500 that has characteristics with reduced temperature dependence is schematically illustrated in FIG. 5A. The fibers 506 and 508 are mounted within the dual fiber ferrule 502. The lens 504 may be provided with a flat surface 505 for mounting against a corresponding surface 507 of the lens/element mount 510 using an adhesive. A ferrule sleeve 512 may be attached to the outside of the ferrule 502 and the ferrule inserted in the mount 510, with the sleeve face 520 against the ferrule-mounting face 522 at the end of the mount 510. The sleeve 512 is mounted at a distance from the end of the ferrule 502 that ensures that the fibers 506 and 508 are correctly spaced from the lens 504.

An optical element 516, for example a filter, or the like, is mounted to a mounting surface 518 of the mount 510 using an adhesive. The element 516 may have a circular cross-section, but may also have a non-circular cross-section. The illustrated example of filter 516 has a rectangular or square cross-section, which is conveniently fabricated from slicing and dicing a large sheet. An expanded view of a cross-section of the mount 510 is illustrated in FIG. 5B, showing the lens and element mounting surfaces 507 and 518.

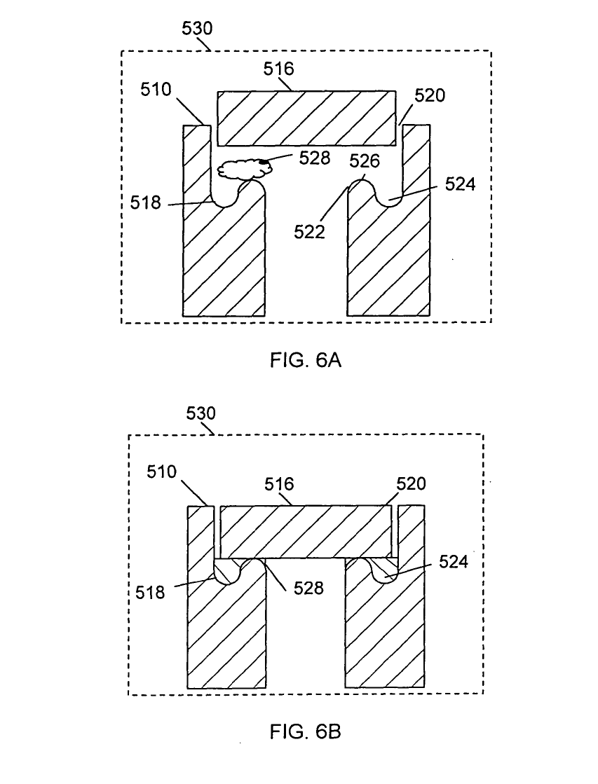

A cross-section through part of the mount 510 is schematically illustrated in FIG. 6A. The element mounting surface 518 may be provided in a recess 520, although this is not a requirement. The element mounting surface 518 includes a raised portion 522 and may also include a well 524 on one or both sides of the raised portion 522. In the illustrated embodiment, a well 524 is provided on one side of the raised portion 522. The raised portion 522 presents a tip 526 for contacting the element 516, rather than a flat surface. The element 516 is shown close to the mounting surface 518, with adhesive 528 disposed between the element 516 and the mounting surface 518, prior to mounting.

As the element 516 is forced towards the mounting surface 518, the adhesive 528 is expelled from the region between the tip 526 and the element 516 until the element 516 contacts the tip 526. The expelled adhesive 528 flows away from the tip 526, down one or both sides of the raised portion 522, and may flow to the well 524. The well 524 need not be filled with expelled adhesive 528. Since the tip 526 has a very small area, it is possible to overcome capillary action and expel the adhesive 528 entirely from between the tip 526 and the element 516, so that the element 516 contacts the tip 526, as illustrated in FIG. 6B. The lens/filter mount 510, filter 516 and adhesive 528 are raised in temperature, preferably to a temperature higher than the expected operating temperature of the resulting fiber optic device. The adhesive 528 is then cured at the high temperature.

After curing, the assembly 530 comprising the mount 510, element 516 and adhesive 528 is allowed to cool. The adhesive 528 cools under tension. The adhesive 528 has a higher thermal expansion coefficient than the mount 510. As long as the operating temperature of the assembly 530 is less than the cure temperature, the adhesive 528 remains in tension, pulling the element 516 toward the mounting surface 518. Since the element 516 is in actual contact with the mounting surface 518 at the contact tips 526, the element 516 does not move relative to the mount 510 as the temperature changes within the operating range. Consequently, when the operating temperature of the assembly 530 varies, the element 516 does not tilt with respect to the mount 510, thus reducing the temperature dependence of the device's operating characteristics. For example, where the assembly 530 is employed in a tap monitor, the temperature dependence of the coupling and insertion losses may be reduced as a result of the mounting technique just described.

One example of a suitable adhesive 528 is type 353 NDT produced by Epotek Corp., Billerica, Mass. This is a two-part epoxy that is cured thermally. Furthermore, the type 353 NDT epoxy is thixotropic, which reduces the ability of the adhesive to flow even under elevated temperatures. Thus, the adhesive does not flow along the surface of the filter 516 while curing. Other types of adhesive that cure at elevated temperatures may also be used.

In one particular embodiment, the mount 510 was manufactured from a martensitic, Se-doped stainless steel, type 182. The mount 510 was mounted in a jig and the mixed epoxy was applied to the mounting surface 518. The element 516, in the form of a multilayer dielectric filter formed on a substrate of B270 glass and presenting a face approximately 1.5 mm×1.5 mm to the mount 510, was forced against the mounting surface 518 with a force of 1 N, and the jig assembly was inserted into an oven for curing at 120° C. for 30 mins.

It will be appreciated that other optical elements, and not only an optical filter, may be mounted in a similar manner. For example, the lens 504 may be mounted to the mount 510 in the same way in order to reduce movement of the lens due to changing temperature.

A useful figure of merit to describe thermal effects is the temperature dependent loss over the range −20° C. −75°C. in other words how much the loss of the device changes between −20° C. and 75° C. Conventional tap monitors typically have a temperature dependent loss in the range 0.1 dB-0.15 dB. A tap monitor of the design illustrated in FIG. 2 was fabricated with the lens and filter mounted as illustrated in FIG. 6B. The temperature dependent loss of that device was measured to be 0.04 dB, significantly lower than other devices.

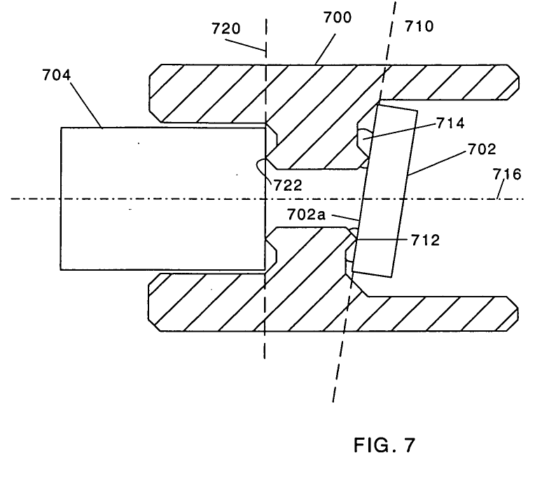

Another important advantage of the present invention over conventional approaches to face mounting is illustrated with respect to FIG. 7. In conventional approaches, for example as illustrated in FIG. 4, the thin layer of adhesive between the element and the mount may vary in thickness at different parts of the mount. Consequently, the element may not be oriented correctly relative to the mounting surface, irrespective of the accuracy of the mounting surface relative to the axis of the mount. Therefore, the transmission and reflection spectra of the device may not be as designed, and may differ from part to part. In the approach described herein, the optical element is mounted in contact with the mount, and so the accuracy of the orientation of the face relative to the optical axis is determined by the accuracy of reproducing the mounting face of the mount, and not the uniformity of the adhesive layer.

FIG. 7 schematically illustrates a face mount 700 for a filter 702 and a lens 704. The lens 704 is illustrated as a GRIN lens, although the invention is not so restricted, and the lens 704 may be any other suitable type of lens, for example an aspheric lens. A filter mounting plane 710 is defined by the mounting surface 712 upon which the filter 702 is mounted. Likewise, a lens mounting plane 720 is defined by the mounting surface 722 upon which the lens 704 is mounted. The lens 702 need not be face mounted and may be edge mounted to the inside surface 724 of the mount 700.

Using the mounting technique described above, the filter 702 contacts the filter mounting surface 712 and is pulled towards the filter mounting surface by the adhesive 714. Consequently, the filter surface 702a lies parallel and immediately adjacent to the mounting plane 710, and so the angle of the filter surface 702a relative to the axis 716 is well-controlled.

The mounting surfaces 518 and 712 were shown to be cylindrically symmetric. However, the mounting surfaces 518 and 712 need not be uniform, for example due to manufacturing tolerances. One example of non-uniformity is that the height of the tip 526 above the well 524 may vary tangentially around the mount 510. In such a case, the filter 516 may not contact the entire tip region 526 all the way around the mount 510. The filter 516 does, however, contact at least three points of the raised portion 522 around the mount 510, which provides sufficient filter/tip contact to prevent the filter 516 from moving relative to the mount 510 under conditions of changing temperature. An advantage of this approach to surface mounting optical elements is that, since the element contacts the mounting surface, the surface of the element lies in the plane defined buy the mounting surface. Accordingly, the precision with which the element's surface is oriented is dependent on the precision of manufacturing the mounting surface.

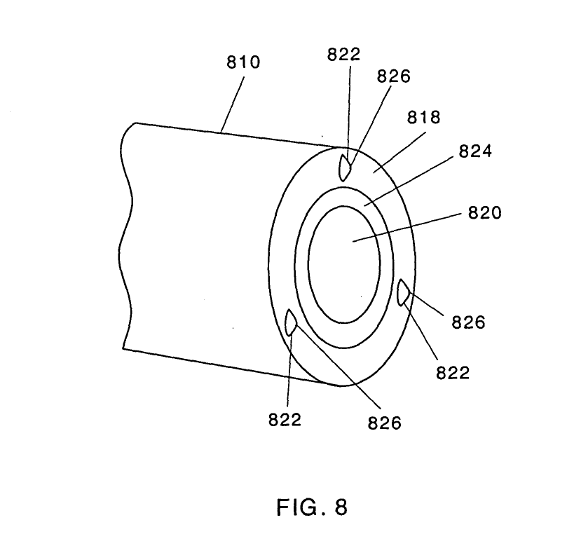

A mount 810 having another type of mounting surface 818 is schematically illustrated in FIG. 8. Although the aperture 820 is circular, raised portions 822, having tips 826, are positioned at various points around the mounting surface 818, rather than being provided as a ring. The three highest tips 826 define a mounting plane on which the surface of the element rests. More raised portions 822 may be provided on the surface 818. A well 824 may extend as a ring around the mount 810, or individual wells (not illustrated) may be provided close to each raised portion 822.

It should be understood that the mount may have a different shape, and need not be cylindrically symmetric. A cylindrical symmetry is useful because the mount can be readily manufactured by turning. Other geometries may be used, for example, the mount may have a square or rectangular cross-section.

As noted above, the present invention is applicable to fiber optic devices and is believed to be particularly useful in fiber optic devices that use one or more surface-mounted elements. It will be appreciated that the invention is not restricted to mounting filters, but may be used for mounting any surface-mounted optical element. Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification.

We claim:

1. A method of mounting an optical element to a mount for use in a predetermined temperature range, the mount having a protruding tip contact region on a mounting surface, the method comprising:
providing adhesive between the optical element and the mounting surface;
pressing the optical element into contact with the protruding contact tip region thereby substantially expelling the adhesive from between the optical element and the protruding contact tip region; and
curing the adhesive at a temperature exceeding the predetermined temperature range.

2. A method as recited in claim 1, wherein providing the mount with a protruding contact tip region includes providing the protruding contact tip region as a ring around a light transmission aperture of the mount.

3. A method as recited in claim 1, wherein providing the mount with a protruding contact tip region includes providing at least three individual contact tips on the mounting surface to define a mounting plane.

4. A method as recited in claim 1, wherein providing the adhesive includes providing a thermally curing epoxy between the optical element and the mount.

5. A method as recited in claim 1, further comprising curing the adhesive contacting between the mounting surface and the optical element while the protruding contact tip region contacts the optical element.

6. A method as recited in claim 1, wherein, after curing, the adhesive remains under tension for temperatures within the predetermined temperature range.

7. A method as recited in claim 1, wherein providing the adhesive includes providing thixotropic adhesive.

8. An optical device for use in a predetermined temperature range, comprising:
a mount having a first mounting surface provided with a protruding tip contact region, the protruding tip contact region defining a mounting plane;
an element to be mounted having a second mounting surface contacting the protruding tip contact region; and
adhesive attachingly disposed between portions of the first and second mounting surfaces not in mutual contact.

9. A device as recited in claim 8, wherein the adhesive remains under tension for temperatures within the predetermined temperature range.

10. A device as recited in claim 8, wherein the predetermined temperature range lies within the range −20° C. to 75° C.

11. A device as recited in claim 8, wherein the protruding contact tip region is disposed around a light transmission aperture of the mount to define the mounting plane.

12. A device as recited in claim 8, wherein the protruding contact tip region includes at least three individual contact tips on the mounting surface to define the mounting plane.

13. A device as recited in claim 8, wherein the adhesive is a thermally cured epoxy.

14. A device as recited in claim 8, wherein the optical element is a filter.

15. A device as recited in claim 8, wherein the optical element remains in a constant position relative to the mount over the predetermined temperature range.

16. A device as recited in claim 8, wherein the adhesive is a thixotropic adhesive prior to curing

17. A device as recited in claim 8, wherein the adhesive has a thermal expansion coefficient higher than a thermal expansion coefficient of the mount and than a thermal expansion coefficient of the optical element.

18. A device as recited in claim 8, wherein the mounting surface further includes a well proximate the protruding contact tip region.

19. A fiber optic device, comprising:
a mount having a first mounting surface defining a first mounting plane;
an optical element adhesively surface mounted to the first mounting surface of the mount, a second mounting surface of the optical element contacting the first mounting surface of the mount so that the second mounting surface is parallel to the first mounting plane.

20. An optical device as recited in claim 19, wherein the first mounting surface has raised portions defining the first mounting plane.

21. An optical device as recited in claim 19, further comprising a first fiber to input light and collimating unit to collimate the light from the first fiber, the optical element being disposed in the collimated light from the fiber.

22. An optical device as recited in claim 19, further comprising adhesive attachingly disposed between portions of the first and second mounting surfaces not in contact.

23. An optical device as recited in claim 22, wherein the adhesive remains under tension for temperatures within a device operating temperature range.

24. A device as recited in claim 23, wherein the predetermined temperature range lies within the range −20°C. to 75° C.

25. A device as recited in claim 22, wherein the adhesive is a thixotropic adhesive prior to curing.

26. A device as recited in claim 22, wherein the adhesive has a thermal expansion coefficient higher than a thermal expansion coefficient of the mount and than a thermal expansion coefficient of the optical element.

27. A device as recited in claim 19, wherein the first mounting plane is non-orthogonal to a mount axis.

28. A device as recited in claim 19, wherein the optical element is a filter.

29. A device as recited in claim 19, wherein the optical element remains in a constant position relative to the mount over the predetermined temperature range.

30. A device as recited in claim 19, wherein the first mounting surface further includes a well proximate protruding contact tip region.
